(19) United States
(12) Patent Application Publication
(10) Pub. No.: US 2025/0173783 A1
(43) Pub. Date: May 29, 2025

(54) SYSTEMS AND METHODS FOR MODIFYING A SAVINGS PLAN BASED ON USER DATA

(71) Applicant: Wells Fargo Bank, N.A., San Francisco, CA (US)

(72) Inventors: Siddartha Pamulaparty, Charlotte, NC (US); Eileen M Holcomb, New York, NY (US)

(21) Appl. No.: 18/523,809

(22) Filed: Nov. 29, 2023

(51) Int. Cl. G06Q 40/02

(52) U.S. Cl. CPC G06Q 40/02

(57) ABSTRACT

Systems, apparatuses, methods, and computer program products are disclosed for modifying a savings plan based on user data. An example method includes receiving personalized data related to a user, anonymized data related to a group of users, and a savings plan and providing the received data to a generative artificial intelligence (GAI) model. The example method further includes generating, using the GAI model, a plan update recommendation and generating, by scenario circuitry, a counterfactual scenario based on the savings plan and the plan update recommendation, which includes outcome changes based on behavior of the user from the personalized data. The example method further includes presenting the plan update recommendation and the counterfactual scenario to the user and receiving a response. The example method further includes, in an instance in which the user accepts the plan update recommendation, updating the savings plan according to the plan update recommendation.

### BACKGROUND

Financial institutions may offer various savings plans to give customers options to achieve their savings goals. Customers may have specific short-term savings goals, and may have trouble achieving those goals using the savings plans available to them. Similarly, sellers may market certain products with product-specific financing plans, which may come with additional risks or costs.

### BRIEF SUMMARY

Customers often want to access savings plans that are personalized to their needs, motivating financial institutions to provide a variety of plan offerings in hopes of covering several potential customer use cases. More specifically, customers may have individualized short-term savings goals, and may desire highly-tailored savings plans for individual goals or even individual purchases. At the same time, sellers now often wish to include financing plans to further motivate customers to purchase products with the advantage of convenient financing at the point of sale. Sellers may also offer a variety of payment options, gift cards, rewards programs, and other ways to pay for purchases that may be confusing for customers, and these options may be under-utilized due to forgetfulness or confusion surrounding the applicability of different payment options.

Existing services to recommend savings goals and help customers keep to their savings goals are often too general and do not include specific, real-time information about the customer's current location and day-to-day changes in spending. Existing approaches may also lack the ability to present customers with a realistic picture of how a change in spending, saving, or other behavior may result in a change in finances at a later time. There is also typically no way to integrate these personalized savings goals into community efforts for multiple users, such as fundraising, family savings, or the like.

In contrast to these conventional techniques for savings and/or credit recommendations, example embodiments described herein provide short-term, highly personalized goals based on the customer's learned interest and patterns. Example embodiments provide similarly personalized recommendations for changes in behavior and specific illustrations of how the changes may influence the customer's goals. In particular, example embodiments may leverage a mobile application that maintains a holistic picture of the customer's finances and assets (including but not limited to transactions about vehicles, rewards card points, cash, personal property, and the like), in combination with contextual information (such as geolocation data retrieved from the mobile device, interactions with the user via any available communication channels such as mobile applications, websites, phone calls, or the like), and uses this holistic picture to recommend highly targeted savings goals or credit plans. In addition, the mobile application may use the same information to analyze financial habits and recommend personalized changes that achieve these savings goals more effectively.

To produce these hyper-personalized recommendations, some example embodiments may leverage a generative artificial intelligence (GAI) model hosted by a backend server. The GAI model may be trained using historical data from the similar existing customer data to identify contexts demonstrating when users are interested in significant purchases (e.g., location, web browser, and mobile application interactions highly correlated with purchasing a particular product) and recommend one or more small-dollar savings targets to the customer. For example, the system may detect based on information related to the customer (e.g., lease-related financial transactions, geolocation information, etc.) that the customer's vehicle lease is ending, and recommend saving up for a new vehicle lease as a savings target. The same (or a second) GAI model may be trained primarily on the user's financial profile to identify these small-dollar “safe-to-save” opportunities.

In some embodiments, savings goals may be suggested to the user that may be short-term and may additionally use customized savings plans offered by a bank or other financial institution. For example, a plan may round up a daily coffee purchase and place the additional rounded amount in a specialized savings account, based on learning the customer buys coffee several times per week. The mobile application may place other such personalized restrictions and/or incentives on the savings plans in order to tailor the savings plan to the customer's individual needs. The goals of the savings plans may also be decided based on the customer's spending habits, frequently visited vendors, or the like.

When a savings goal has been selected, some example embodiments may make specific recommendations to encourage the customer's behavior towards saving for the goal. For example, a customer that buys an extra pastry with a coffee on some mornings may be prompted to redirect the cost of the pastry into the savings account, with the added incentive of displaying how foregoing the pastry every day will accelerate the customer's savings goal. The recommendations may be provided in a personalized, timely manner that is targeted to enhance the impact and likelihood to achieve the savings goal. In another example, example embodiments may direct a customer to purchase coffee at a different location where a cheaper option is available, redirect the savings into a specific savings plan, and inform the customer that taking these steps may allow the customer to purchase a desired product after a certain number of months.

Example embodiments disclosed herein may further incorporate group dynamics, social media, crowdfunding, and the like to achieve community savings goals. For example, a group of flatmates may receive a personalized savings goal pertinent to the group, for example, new furniture, larger or more desirable apartments at a specified level of rant, and the like. Group savings goals may also include charitable aims, such as crowdfunding. Example embodiments may provide recommendations for specific behavior changes (e.g., purchasing, saving changes) that may impact the group goals. Customers may be able to share personalized or anonymized data, depending on the nature of the group and the goals, to motivate other group members to participate in the savings plan.

Accordingly, the present disclosure sets forth systems, methods, and apparatuses that provide highly personalized savings goal recommendations. There are many advantages of these and other embodiments described herein. For instance, vendors benefit from the generation of highly specific savings plans for purchase of their products. By encouraging customers to save for a particular desired product, a larger market is made available, while avoiding the costs and difficulties of retail loans. In addition, community aspects of saving encourage users to work together for larger savings targets. By creating a sense of connection with other users on a community or shared savings plan, a strong motivation is provided for larger savings goals. Finally, counterfactual scenarios and highly specific recommendations create a concrete connection between actions and results for customers. Seeing a specific recommended savings plan will increase customer confidence in their ability to save up for a particular savings goal.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for modifying a savings plan based on user data.

FIG. 2 illustrates a schematic block diagram of example circuitry embodying a system device that may perform various operations in accordance with some example embodiments described herein.

FIG. 3 illustrates an example flowchart for modifying a savings plan based on user data, in accordance with some example embodiments described herein.

FIG. 4 illustrates an example flowchart for receiving a savings plan related to a user, in accordance with some example embodiments described herein.

FIG. 5 illustrates an example graphical user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “personalized data” may refer data related to a user that may be individualized information collected from the user in digital contexts, such as interactions with applications, websites, or the like. The data may include demographic details, browsing behavior, preferences, historical interactions, location data, device information, and the like. The personalized user data may form the basis for personalized recommendations provided to the user by various circuitry of the apparatus 200.

The term “anonymized data” may refer to data related to a group of users that may be information collected from a large number of users in digital contexts, much like personalized data, however the data may be lacking individualized information about the identity of the user. The aggregated anonymized data may form the basis for personalized recommendations provided to the user by various circuitry of the apparatus 200, particularly in instances in which personalized data is unavailable or a larger aggregation of usage data is desirable for a recommendation.

The term “savings plan” may refer to structured data describing particulars of a financial product related to a user, including interest rates, deposit minimums and/or maximums, dates and times of validity, frequency of deposits and or withdrawals, fee arrangements, and any other details that may fully describe the financial product. In some embodiments, the financial product is a short-term savings account, designed and targeted to reach a certain account balance at a certain time. The short-term savings account may require a sequence of specified deposits within specified time windows, and there may exist restrictions on the withdrawal of funds. In some embodiments, the savings plan may restrict the funds to be used for a pre-determined product, or to be spent or transferred to a pre-determined vendor. The savings plan may be structured as any data structure known in the art (files, application programming interface (API) messages, or other means of transmitting data) and may be bundled or packaged with other data such as the personalized data or anonymized data. In some embodiments, a savings plan may include incentives or stipulations regarding the use of certain types of vendor incentives, point rewards programs, vendor cash, or the like. The term savings plans, as used here, may also encompass certain other financial products including short-term loans, lines of credit, and/or financing for particular purchases.

### System Architecture

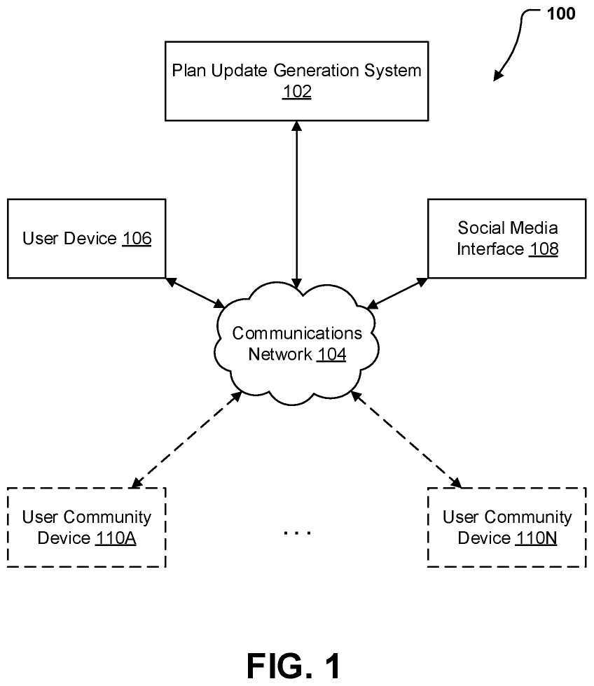

Example embodiments described herein may be implemented using any of a variety of computing devices or servers. To this end, FIG. 1 illustrates an example environment 100 within which various embodiments may operate. As illustrated, a plan update generation system 102 may receive and/or transmit information via communications network 104 (e.g., the Internet) with any number of other devices, such as one or more of user device 106, social media interface 108, and/or user community devices 110A-110N.

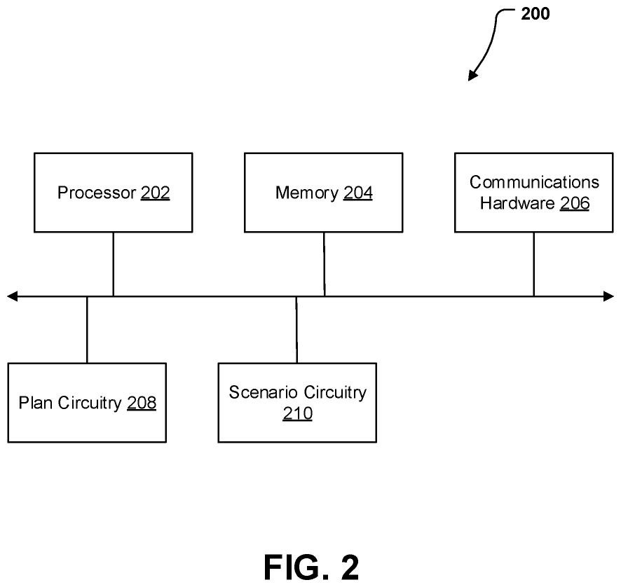

The plan update generation system 102 may be implemented as one or more computing devices or servers, which may be composed of a series of components. Particular components of the plan update generation system 102 are described in greater detail below with reference to apparatus 200 in connection with FIG. 2.

The user device 106, social media interface 108, and one or more user community devices 110A-110N may be embodied by any computing devices known in the art. The user device 106, social media interface 108, and one or more user community devices 110A-110N need not themselves be independent devices, but may be peripheral devices communicatively coupled to other computing devices.

The social media interface 108 may be a computing device configured to perform an authentication process for a user to access a social media network or service. In some embodiments, the social media interface 108 may be a cloud service or virtual service, or the social media interface 108 may be embodied as a particular device or devices. The social media interface 108 may receive messages to be posted to a social media platform form authenticated users, and may further provide social media posts and other content to authenticated users.

Although FIG. 1 illustrates an environment and implementation in which the plan update generation system 102 interacts indirectly with a user via user device 106, in some embodiments users may directly interact with the plan update generation system 102 (e.g., via communications hardware of the plan update generation system 102), in which case a separate user device 106 may not be utilized. Whether by way of direct interaction or indirect interaction via another device, a user may communicate with, operate, control, modify, or otherwise interact with the plan update generation system 102 to perform the various functions and achieve the various benefits described herein.

### Example Implementing Apparatuses

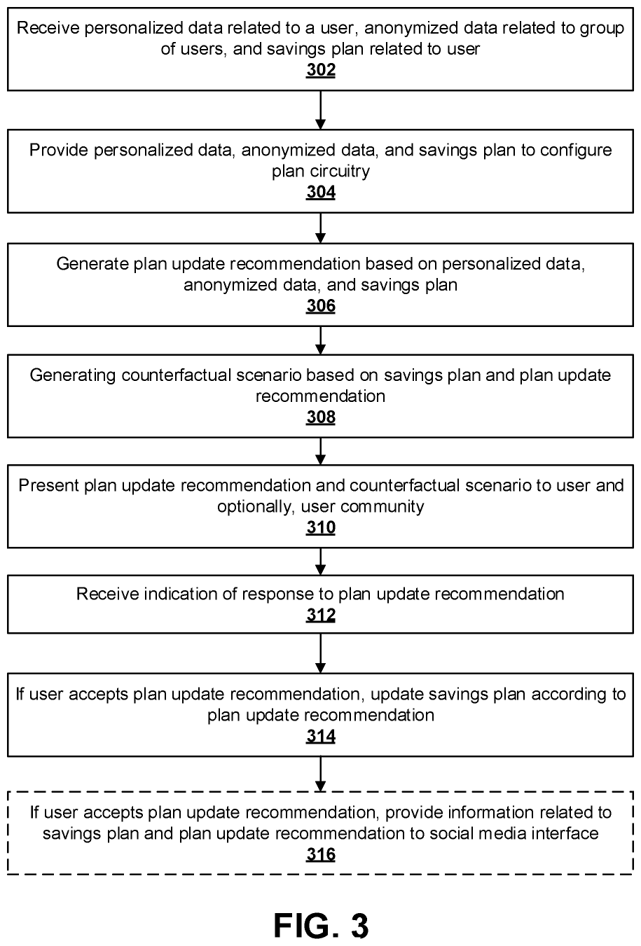

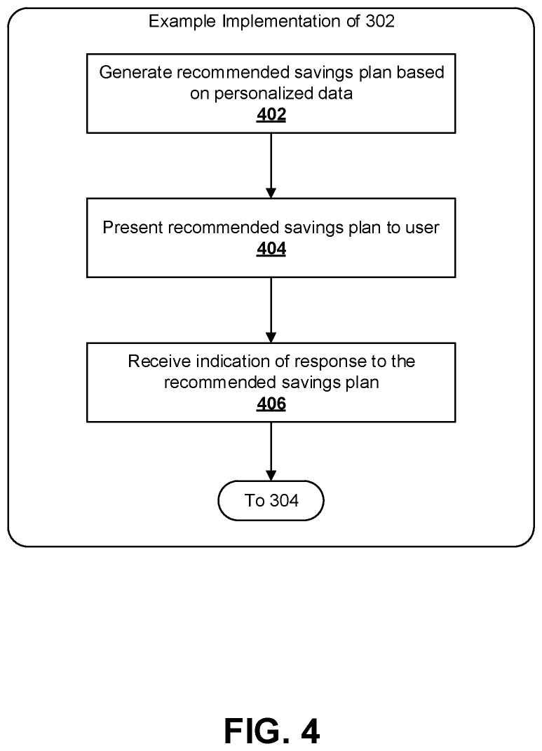

The plan update generation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-4. As illustrated in FIG. 2, the apparatus 200 may include processor 202, memory 204, communications hardware 206, plan circuitry 208, and scenario circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a plan circuitry 208 that generating a plan update recommendation based on personalized data, anonymized data, and a savings plan and updating the savings plan according to a plan update recommendation. The plan circuitry 208 may utilize processor 202, memory 204, or any other hardware component included in the apparatus 200 to perform these operations, as described in connection with FIGS. 3-4 below. The plan circuitry 208 may further utilize communications hardware 206 to gather data from a variety of sources (e.g., user device 106 or social media interface 108, as shown in FIG. 1), and/or exchange data with a user, and in some embodiments may utilize processor 202 and/or memory 204 to generate and update plan recommendations.

In addition, the apparatus 200 further comprises a scenario circuitry 210 that generates a counterfactual scenario based on a savings plan and a plan update recommendation. The scenario circuitry 210 may utilize processor 202, memory 204, or any other hardware component included in the apparatus 200 to perform these operations, as described in connection with FIGS. 3-4 below. The scenario circuitry 210 may further utilize communications hardware 206 to gather data from a variety of sources (e.g., user device 106 or social media interface 108, as shown in FIG. 1), and/or exchange data with a user, and in some embodiments may utilize processor 202 and/or memory 204 to generate a counterfactual scenario.

Although components 202-210 are described in part using functional language, it will be understood that the particular implementations necessarily include the use of particular hardware. It should also be understood that certain of these components 202-210 may include similar or common hardware. For example, the plan circuitry 208 and scenario circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the plan circuitry 208 and scenario circuitry 210 may leverage processor 202, memory 204, or communications hardware 206 as described above, it will be understood that any of plan circuitry 208 and scenario circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that plan circuitry 208 and scenario circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

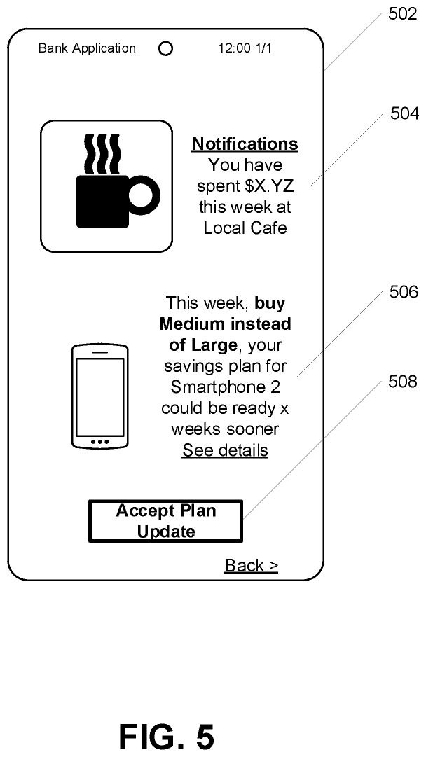

Turning to FIGS. 3 and 4, example flowcharts are illustrated that contain example operations implemented by example embodiments described herein. The operations illustrated in FIGS. 4 and 5 may, for example, be performed by the plan update generation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, plan circuitry 208, scenario circuitry 210, and/or any combination thereof. It will be understood that user interaction with the plan update generation system 102 may occur directly via communications hardware 206, or may instead be facilitated by a separate user device 106, as shown in FIG. 1, and which may have similar or equivalent physical componentry facilitating such user interaction.

Turning first to FIG. 3, example operations are shown for modifying a savings plan based on user data. As shown by operation 302, the apparatus 200 includes means, such as processor 202, memory 204, communications hardware 206, or the like, for receiving personalized data related to a user, anonymized data related to a group of users, and a savings plan related to the user. In some embodiments, receiving the savings plan related to the user may be performed in accordance with the operations described by FIG. 4 below.

The personalized data related to the user may be individualized information collected from the user in digital contexts, such as interactions with applications, websites, or the like. The data may include demographic details, browsing behavior, preferences, historical interactions, location data, device information, and the like. The personalized user data may form the basis for personalized recommendations provided to the user by various circuitry of the apparatus 200.

The anonymized data related to a group of users may be information collected from a large number of users in digital contexts, much like personalized data, however the data may be lacking individualized information about the identity of the user. The aggregated anonymized data may form the basis for personalized recommendations provided to the user by various circuitry of the apparatus 200, particularly in instances in which personalized data is unavailable or a larger aggregation of usage data is desirable for a recommendation.

The savings plan related to the user may be structured data describing particulars of a financial product including interest rates, deposit minimums and/or maximums, dates and times of validity, frequency of deposits and or withdrawals, fee arrangements, and any other details that may fully describe the financial product. In some embodiments, the financial product is a short-term savings account, designed and targeted to reach a certain account balance at a certain time. The short-term savings account may require a sequence of specified deposits within specified time windows, and there may exist restrictions on the withdrawal of funds. In some embodiments, the savings plan may restrict the funds to be used for a pre-determined product, or to be spent or transferred to a pre-determined vendor. The savings plan may be structured as any data structure known in the art (files, application programming interface (API) messages, or other means of transmitting data) and may be bundled or packaged with other data such as the personalized data or anonymized data. In some embodiments, a savings plan may include incentives or stipulations regarding the use of certain types of vendor incentives, point rewards programs, vendor cash, or the like. The term savings plans, as used here, may also encompass certain other financial products including short-term loans, lines of credit, and/or financing for particular purchases.

In some embodiments, the savings plan is further related to a user community comprising the user. The user community may be a group or set of users. The user community may be user-defined, wherein users may add themselves or be added to the user community by another user. In some embodiments, the user community may be automatically and/or procedurally generated, for example, a user community including users who visit a particular local coffee shop more than three times per week. In some embodiments, users may freely add or remove themselves from user communities, and in some embodiments, user communities may be private or require approval or vetting for users to join. The savings plan may be related to a user community by providing incentives or benefits for all members of the community, or by including certain requirements that depend on members of the community. For example, a savings plan may unlock a higher interest rate if members of the community complete a specified number of purchases at a participating retailer, or a discount may be offered on a purchase at a participating retailer if user community members reach a certain savings goal collectively.

In some embodiments, the savings plan comprises a crowdfunding savings goal. For example, a savings plan may be targeted towards a charitable aim that is expressed as a crowdfunding goal. Individual users may contribute to the crowdfunding goal to contribute to the charitable aim. The savings plan may include certain incentives or rewards for reaching certain levels or contributing certain amounts to crowdfunding goals, such as in-application badges or displays or other digital rewards.

As shown by operation 304, the apparatus 200 includes means, such as processor 202, memory 204, communications hardware 206, plan circuitry 208, or the like, for providing the personalized data, the anonymized data, and the savings plan for configuration of a plan circuitry 208. The plan circuitry 208 may ingest the personalized data, the anonymized data, and the savings plan into a generative artificial intelligence (GAI) model. The GAI model may employ deep learning techniques, for example, based on neural network architectures, to understand the ingested data and generate meaningful and contextual responses. The GAI model may be trained on a large dataset to comprehend natural language prompts and generate responses in a variety of contexts, and domain-specific information regarding savings plans, finance, and the like may also be used for training. In some embodiments, the plan circuitry 208 may engineer a prompt, where the prompt provides context and also may encapsulate the personalized data, the anonymized data, and/or the savings plan. In some embodiments, the plan circuitry 208 may use an API to directly feed the personalized data, the anonymized data, and/or the savings plan to the GAI model. In some embodiments, the prompt may describe a request to generate a plan update recommendation.

As shown by operation 306, the apparatus 200 includes means, such as processor 202, memory 204, communications hardware 206, plan circuitry 208, or the like, for generating a plan update recommendation based on the personalized data, the anonymized data, and the savings plan. In some embodiments, the plan circuitry 208 may use the GAI model to generate the plan update recommendation based on the prompt provided to the GAI model, for example, as described in operation 304. The plan update recommendation may be a proposed change to the savings plan described above. In some embodiments, the plan update recommendation may be presented in natural language, or the plan update recommendation may be presented as a new savings plan (e.g., using the data structure of the savings plan) or a data structure that conveys the changes to be applied to the savings plan. In some embodiments, the plan circuitry 208 may apply cleaning, formatting, or other transformations to the output from the GAI model using a rules-based transformation to prepare the plan update recommendation with the desired formatting. In some embodiments, the plan update recommendation may comprise a new savings plan. For example, the plan update recommendation may be generated in an instance in which no previous savings plan exists.

As shown by operation 308, the apparatus 200 includes means, such as processor 202, memory 204, communications hardware 206, scenario circuitry 210, or the like, for generating a counterfactual scenario based on the savings plan and the plan update recommendation, wherein the counterfactual scenario comprises a set of outcome changes based on applying the plan update recommendation to the savings plan and further based on behavior of the user from the personalized data. The scenario circuitry 210 may analyze the savings plan and the plan update recommendation and may further use the context of the personalized data and anonymized data to generate the counterfactual scenario using a rules-based analysis of the available data. The counterfactual scenario may provide an indication of the effects of a change in behavior over a given period of time, particularly by comparing outcomes with a savings plan compared to the updated savings plan with the update recommendation applied. In some embodiments, the counterfactual scenario may compare a scenario in which no previous savings plan is used to a recommended update to a savings plan or a new savings plan.

For example, the user may have a savings plan that is generalized or not specified to the user's spending habits. The plan circuitry 208 may present a plan update recommendation based on the user's preference to purchase a coffee and pastry from the same café several times each week. The updated plan may have required weekly deposits of an amount equal to the cost of the user's usual pastry purchases at the café. The counterfactual scenario may include a determination that the user may be able to save enough money for a new phone after putting money into savings in place of the user's usual pastry purchases for a duration of a certain number of weeks.

In some embodiments, the counterfactual scenario further comprises a health impact for the user. To continue the previous example, the counterfactual scenario may include the number of calories and grams of fat the user may avoid over the course of the counterfactual scenario duration by abstaining from the usual pastry purchases and saving the money instead. In another example, the counterfactual scenario may include shopping at a nearby café that offers a cheaper coffee, but requires five extra minutes of walking each day to reach. The counterfactual scenario may include the total number of steps walked per week as a health benefit to saving money by shopping at the farther café with the cheaper coffee.

In some embodiments, the counterfactual scenario further comprises an analysis of time requirements for the user. To continue the previous example, the counterfactual scenario may include an estimation of the total time required each day to travel to a different café with cheaper coffee, and display the total time investment needed per week to save the targeted amount of money. The user may then be able to more easily determine if they think it is worth their time to take the proposed actions to save the amount of money determined by the plan. In another example, the counterfactual scenario may involve walking or biking to work instead of paying for parking in a garage near the user's workplace. The counterfactual scenario may further estimate the amount of time needed per day or per week to avoid paying for parking. The counterfactual scenario may also include the health impacts of biking or walking, as discussed previously.

In some embodiments, the counterfactual scenario involves the user community, and the counterfactual scenario further comprises a set of community outcome changes based on behavior of the user community from the anonymized data. For example, a plan update recommendation may generate a group plan for a user community that raises money for a charitable cause. The counterfactual scenario may determine that if each member of the community diverted the cost of one dessert item per week, the user community's charitable savings goal could be reached within a specified amount of time. In some embodiments, the anonymized data may be used to create more detailed counterfactual scenarios, for example determining the impact if each member of the user community diverted 1% of their food budget each week and preparing this counterfactual scenario for the user.

In some embodiments, generation of the plan update recommendation and/or the generation of the counterfactual scenario may occur in real-time or substantially concurrent with the initiating event. For example, generation of the plan update recommendation and/or the generation of the counterfactual scenario may occur between the time that a customer walks into a business and begins to order from the business, or on the order of seconds. Real-time generation of the plan update recommendation and/or the generation of the counterfactual scenario may be possible due to the configuration of the plan circuitry 208 and/or scenario circuitry 210, which may automatically receive the initiating event data and generate outputs based on the initiating event data.

As shown by operation 310, the apparatus 200 includes means, such as processor 202, memory 204, communications hardware 206, plan circuitry 208, or the like, for presenting the plan update recommendation and the counterfactual scenario to the user. The communications hardware 206 may present the plan update recommendation and the counterfactual scenario to the user, for example, by transmitting the plan update recommendation and the counterfactual scenario to a user device 106. The plan update recommendation and the counterfactual scenario may be displayed to the user by the user device 106 upon receiving the transmission from the communications hardware 206. In some embodiments, the plan update recommendation and the counterfactual scenario may be displayed as an email message, in-application message, push notification, SMS message, phone call, voice message, and/or any other messaging capability of the user device 106 known in the art. The plan circuitry 208, communications hardware 206 and/or the user device 106 may interpret the plan update recommendation and the counterfactual scenario in their original data structures to present a human-readable form of the plan update recommendation and the counterfactual scenario to the user.

In some embodiments, the apparatus 200 includes means, such as processor 202, memory 204, communications hardware 206, or the like, for presenting the plan update recommendation and the counterfactual scenario to the user community. As described above, the communications hardware 206 and/or the user device 106 may present the plan update recommendation and the counterfactual scenario to the user. In some embodiments, the communications hardware 206 and/or one or more user community devices 110A-110N may present the plan update recommendation and the counterfactual scenario. In some embodiments, the plan update recommendation and the counterfactual scenario may relate to a user community, and the same user community may receive the presented plan update recommendation and the counterfactual scenario via the one or more user community devices 110A-110N.

As shown by operation 312, the apparatus 200 includes means, such as processor 202, memory 204, communications hardware 206, or the like, for receiving, from the user, an indication of a response to the plan update recommendation. The communications hardware 206 may receive the response directly or via user device 106. The user may provide the indication, for example, via a graphical user interface (GUI) presented by the user device 106, by replying by email, SMS, or any other communication capabilities of the user device 106. In some embodiments, one or more members of a user community may similarly provide an indication of a response using one or more user community devices 110A-110N. In some embodiments, the indication of the response to the plan update recommendation may include accepting or rejecting the plan update recommendation.

As shown by operation 314, the apparatus 200 includes means, such as processor 202, memory 204, communications hardware 206, plan circuitry 208, or the like, for in an instance in which the user accepts the plan update recommendation, updating the savings plan according to the plan update recommendation. The plan circuitry 208 may update the savings plan by applying the plan update recommendation. In some embodiments, the plan update recommendation comprises a new savings plan, and the original savings plan may be removed or deleted and replaced by the new savings plan. In some embodiments, the savings plan recommendation may include a data structure containing the changes to the savings plan, and the plan circuitry 208 may apply the changes to the savings plan to implement the plan update recommendation.

Finally, as shown by operation 316, the apparatus 200 includes means, such as processor 202, memory 204, communications hardware 206, or the like, for providing information related to the savings plan and the plan update recommendation to a social media interface 108. The communications hardware 206 may provide the plan update recommendation and/or the counterfactual scenario to a social media interface 108 to share details about the plan update recommendation and/or the counterfactual scenario on a social media platform, crowdfunding platform, and/or the like. In some embodiments, the user may be presented with a GUI element that presents the choice of sharing the updated savings plan to social media, and interacting with the GUI element may cause the communications hardware 206 to provide certain details of the plan update recommendation and/or the counterfactual scenario to the social media interface 108. The social media interface 108, as described previously, may be a gateway for the user to provide and receive social media posts, updates, and other communications to one or more social media sites or platforms. In some embodiments, the social media update may be send to members of a user community group via the social media platform.

In some embodiments, operation 302 may be performed in accordance with the operations described by FIG. 4. Turning now to FIG. 4, example operations are shown for receiving a savings plan related to the user. As shown by operation 402, the apparatus 200 includes means, such as processor 202, memory 204, communications hardware 206, plan circuitry 208, or the like, for generating a recommended savings plan based on the personalized data. In some embodiments, the plan circuitry 208 may use a method similar to operation 306 for generating a savings plan. In some embodiments, the plan circuitry 208 may use a GAI model to generate the savings plan based on a prompt provided to the GAI model, for example, the savings plan may be presented in natural language, or the savings plan may be presented as structured data (e.g., comma separated values, JSON, YAML, or the like). In some embodiments, the plan circuitry 208 may apply cleaning, formatting, or other transformations to the output from the GAI model using a rules-based transformation to prepare the savings plan with the desired formatting.

As shown by operation 404, the apparatus 200 includes means, such as processor 202, memory 204, communications hardware 206, or the like, for presenting the recommended savings plan to the user. The communications hardware 206 and/or the user device 106 may present the savings plan and, in some embodiments, a corresponding counterfactual scenario to the user. In some embodiments, the communications hardware 206 and/or one or more user community devices 110A-110N may present the savings plan and/or the counterfactual scenario. In some embodiments, the savings plan and/or the counterfactual scenario may relate to a user community, and the same user community may receive the presented savings plan and the counterfactual scenario via the one or more user community devices 110A-110N.

Finally, as shown by operation 406, the apparatus 200 includes means, such as processor 202, memory 204, communications hardware 206, or the like, for receiving an indication of a response to the recommended savings plan. The communications hardware 206 may receive the response directly or via user device 106. The user may provide the indication, for example, via a GUI presented by the user device 106, by replying by email, SMS, or any other communication capabilities of the user device 106. In some embodiments, one or more members of a user community may similarly provide an indication of a response using one or more user community devices 110A-110N. In some embodiments, the indication of the response to the recommended savings plan may include accepting or rejecting the recommended savings plan.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3-4 may be modified or further amplified. Furthermore, in some embodiments, additional optional operations may be included. Modifications, amplifications, or additions to the operations above may be performed in any order and in any combination.

Turning to FIG. 5, a graphical user interface (GUI) is provided that illustrates presenting a plan update recommendation to a user. As noted previously, a user may interact with the plan update generation system 102 by directly engaging with communications hardware 206 of an apparatus 200 embodying the plan update generation system 102. In such an embodiment, the GUI shown in FIG. 5 may be displayed to a user by the apparatus 200. Alternatively, a user may interact with the plan update generation system 102 using a separate user device 106 (as shown in FIG. 1), which may communicate with the plan update generation system 102 via communications network 104. In such an embodiment, the GUI shown in FIG. 5 may be displayed to the user by the user device 106.

The plan update recommendation may be displayed using a GUI displayed on a user device 106, such as a smartphone 502. The smartphone 502 may present a notification 504 to the user based on personalized data of the user. The GUI may also display one or more details of the counterfactual scenario 506, and may include a GUI element for displaying more details about the counterfactual scenario and the plan update recommendation. The GUI may also include a button 508 that may be interacted with to provide an indication of accepting the plan update recommendation.

The GUI 502 exemplifies a plan update recommendation that may appear in real-time (e.g., within a short time on the order of seconds) in reaction to the initiating event. For example, a customer may walk into a coffee shop and immediately see the notification illustrated in FIG. 5. The technical approach of example embodiments disclosed herein thus provides the ability to offer guidance on a time scale that a human sales agent would be unable to provide.

### CONCLUSION

As described above, example embodiments provide methods and apparatuses that enable improved personalized savings plan recommendations. Example embodiments thus provide tools that overcome the problems when providing customized financial products to customers. Moreover, embodiments described herein incorporate social media and community-based dynamics that improve customer engagement with the financial services offered.

As these examples all illustrate, example embodiments contemplated herein provide technical solutions that solve real-world problems faced when developing financial product recommendations for customers. Moreover, the explosive growth in the volume of data made available by user engagement with smart devices and other Internet-connected components renders manual solutions for data-based personalization intractable. Accordingly, the use of generative artificial intelligence technology provides a hyper-personalized recommendation solution that has no historical human analog. The ability of example embodiments disclosed herein to offer recommendations in real-time thus presents a technical advantage over existing solutions. At the same time, the increasing ubiquity of electronic payments, online shopping, and larger datasets available for analytics have increased the competitiveness in this domain, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for modifying a savings plan based on user data, the method comprising:
receiving, by communications hardware, personalized data related to a user, anonymized data related to a group of users, and a savings plan related to the user;
providing, by plan circuitry, the personalized data, the anonymized data, and the savings plan to a generative artificial intelligence (GAI) model;
generating, by the plan circuitry and using the GAI model, a plan update recommendation based on the personalized data, the anonymized data, and the savings plan;
generating, by scenario circuitry, a counterfactual scenario based on the savings plan and the plan update recommendation, wherein the counterfactual scenario comprises a set of outcome changes based on applying the plan update recommendation to the savings plan and further based on behavior of the user from the personalized data;
presenting, by the communications hardware, the plan update recommendation and the counterfactual scenario to the user;
receiving, by the communications hardware and from the user, an indication of a response to the plan update recommendation; and
in an instance in which the user accepts the plan update recommendation, updating, by the plan circuitry, the savings plan according to the plan update recommendation.

2. The method of claim 1, wherein receiving the savings plan comprises:
generating, by the plan circuitry, a recommended savings plan based on the personalized data;
presenting, by the communications hardware, the recommended savings plan to the user; and
receiving, by the communications hardware, an indication of a response to the recommended savings plan.

3. The method of claim 1, wherein the counterfactual scenario further comprises a health impact for the user.

4. The method of claim 1, wherein the counterfactual scenario further comprises an analysis of time requirements for the user.

5. The method of claim 1, wherein the savings plan is further related to a user community comprising the user.

6. The method of claim 5, wherein the counterfactual scenario involves the user community, and the counterfactual scenario further comprises a set of community outcome changes based on behavior of the user community from the anonymized data.

7. The method of claim 5, further comprising:
presenting, by the communications hardware, the plan update recommendation and the counterfactual scenario to the user community.

8. The method of claim 5, wherein the savings plan comprises a crowdfunding savings goal.

9. The method of claim 1, further comprising, in the instance in which the user accepts the plan update recommendation, providing, by the communications hardware, information related to the savings plan and the plan update recommendation to a social media interface.

10. An apparatus for modifying a savings plan based on user data, the apparatus comprising:
communications hardware configured to receive personalized data related to a user, anonymized data related to a group of users, and a savings plan related to the user;
plan circuitry configured to:
provide the personalized data, the anonymized data, and the savings plan to a GAI model, and
generate, using the GAI model, a plan update recommendation based on the personalized data, the anonymized data, and the savings plan; and
scenario circuitry configured to generate a counterfactual scenario based on the savings plan and the plan update recommendation, wherein the counterfactual scenario comprises a set of outcome changes based on applying the plan update recommendation to the savings plan and further based on behavior of the user from the personalized data,
wherein the communications hardware is further configured to: present the plan update recommendation and the counterfactual scenario to the user, and
receive, from the user, an indication of a response to the plan update recommendation,
wherein the plan circuitry is further configured to, in an instance in which the user accepts the plan update recommendation, update the savings plan according to the plan update recommendation.

11. The apparatus of claim 10, wherein the plan circuitry is further configured so that receiving the savings plan comprises:
generating a recommended savings plan based on the personalized data;
presenting the recommended savings plan to the user; and
receiving an indication of a response to the recommended savings plan.

12. The apparatus of claim 10, wherein the counterfactual scenario further comprises a health impact for the user.

13. The apparatus of claim 10, wherein the counterfactual scenario further comprises an analysis of time requirements for the user.

14. The apparatus of claim 10, wherein the savings plan is further related to a user community comprising the user.

15. The apparatus of claim 14, wherein the counterfactual scenario involves the user community, and the counterfactual scenario further comprises a set of community outcome changes based on behavior of the user community from the anonymized data.

16. The apparatus of claim 14, wherein the communications hardware is further configured to present the plan update recommendation and the counterfactual scenario to the user community.

17. The apparatus of claim 14, wherein the savings plan comprises a crowdfunding savings goal.

18. The apparatus of claim 10, wherein the communications hardware is further configured to, in the instance in which the user accepts the plan update recommendation, provide information related to the savings plan and the plan update recommendation to a social media interface.

19. A computer program product for modifying a savings plan based on user data, the computer program product comprising at least one non-transitory computer-readable storage medium storing software instructions that, when executed, cause an apparatus to:
receive personalized data related to a user, anonymized data related to a group of users, and a savings plan related to the user;
provide the personalized data, the anonymized data, and the savings plan to a GAI model;
generate, using the GAI model, a plan update recommendation based on the personalized data, the anonymized data, and the savings plan;
generate a counterfactual scenario based on the savings plan and the plan update recommendation, wherein the counterfactual scenario comprises a set of outcome changes based on applying the plan update recommendation to the savings plan and further based on behavior of the user from the personalized data;
present the plan update recommendation and the counterfactual scenario to the user;
receive, from the user, an indication of a response to the plan update recommendation; and
in an instance in which the user accepts the plan update recommendation, update the savings plan according to the plan update recommendation.

20. The computer program product of claim 19, wherein receiving the savings plan comprises:
generating a recommended savings plan based on the personalized data;
presenting the recommended savings plan to the user; and
receiving an indication of a response to the recommended savings plan.
